(19) United States
(12) Patent Application Publication
(10) Pub. No.: US 2016/0291251 A1
(43) Pub. Date: Oct. 6, 2016

(54) Resonant Cavity Component Used in Optical Switching System

(71) Applicant: Huawei Technologies Co., Ltd., Shenzhen (CN)

(72) Inventors: Xin Tu, Wuhan (CN); Hongyan Fu, Shenzhen (CN)

(21) Appl. No.: 15/178,302

(22) Filed: Jun. 9, 2016

Related U.S. Application Data
(63) Continuation of application No. PCT/CN2013/088959, filed on Dec. 10, 2013.

(51) Int. Cl. G02B 6/293

(52) U.S. Cl. CPC G02B 6/29343; G02B 6/29395

(57) ABSTRACT

A resonant cavity component can be used in an optical switching system, and includes a resonant cavity group, where the resonant cavity group includes at least two resonant cavities that have displacement in a vertical direction, and adjacent resonant cavities exchange optical energy by means of evanescent wave coupling; a restriction layer between resonant cavities that has a relatively low refractive index; and at least one optical waveguide, close to a bottom-layer resonant cavity in the resonant cavity group, couples optical energy, and is used to input or output an optical signal. In implementation manners of the present invention, multiple resonant cavities have displacement in a vertical direction, are located in different planes, and may be made by using a CMOS process; and a space in a vertical direction can be controlled to a level of several nanometers.

### CROSS-REFERENCE TO RELATED APPLICATIONS

This application is a continuation of International Application No. PCT/CN2013/088959, filed on Dec. 10, 2013, which is hereby incorporated by reference in its entirety.

### TECHNICAL FIELD

The present invention relates to the field of communications technologies, and in particular, to a resonant cavity component used in an optical switching system.

### BACKGROUND

With continuous expansion of a transmission capacity and continuous increase in a transmission rate of a trunk telecommunications network, fiber optic communications becomes a main transmission means in a modern information network. In a current optical communications network such as a wide area network, a metropolitan area network, and a local area network, there are more types of an optical switching module that is required as one of core optoelectronic components, requirements on the optical switching module are increasingly high, and complexity also develops at an amazing speed. Sharp increase in the optical switching module results in diversity, and related technologies need to be continuously developed to meet such an application requirement. With improvement in semiconductor processing processes, the optical switching module develops in a direction of miniaturization, high density, and low power consumption, where a silicon photonics-based photonic integrated circuit (PIC) chip becomes one of most likely commercial products in a next-generation all-optical switching optical cross-connect (OXC) module.

A silicon-based OXC chip includes various waveguide components, such as an optical switch, a delayer, an energy beamsplitter, and a polarization-dependent component. These components are used for cross-connection, routing, wavelength division multiplexing/demultiplexing, cache, and the like of an optical signal. A type of component based on a closed ring waveguide is generally referred to as a microdisk or microring resonant cavity. The microdisk or microring resonant cavity has a series of specific resonant modes, and a corresponding wavelength meets an equation mλᵣₑₛ=2πnR, where R is an effective radius of the microdisk or microring resonant cavity, n is an effective refractive index of the mode, and λᵣₑₛ is a resonant wavelength corresponding to a longitudinal mode of the m^{th} order. When a column of signal lights whose wavelengths are respectively λ1, λ2, λ3, . . . , λn is coupled to a resonant cavity by using a straight waveguide, only channel lights whose resonant wavelength is the same as the resonant wavelength λᵣₑₛ can be resonant. Although the microdisk or microring resonant cavity is similar to a traditional Fabry-Perot resonant cavity, the microdisk or microring resonant cavity also has a characteristic of wavelength resonance, but has a longer photonic life, lower loss, and a higher quality factor, and is therefore appropriate to be used as various optical communication and information processing components such as an optical filter, an optical wavelength division multiplexer, an optical switch, a nonlinear frequency converter, and a buffer in the OXC chip. From a perspective of physical principles of a component, a coupling cavity component made by using multiple microdisk or microring resonant cavities has better and richer function characteristics than a single microdisk or microring resonant cavity component. For example, a rectangular band-pass spectrum of a higher order filter has steep roll-off, flat band-pass, and an excellent out-of-band side lobe suppression effect, and cascaded multi-ring resonant cavities can increase a group delay of an optical signal. These or microring resonant cavities are generally made in a PIC photonic loop at a same layer, close to each other, coupled by using an evanescent wave, and are formed after being processed by using a semiconductor process (such as photolithography); and reference is made to a reference Higher Order Filer Response in Coupled Microring Resonators, IEEE, Photonics Technology Letters, Vol 12, No. 3, 320 (2000). However, in the foregoing planarly coupled cascaded microring resonant cavities, all microring resonant cavities are located in a same plane; when the planar coupling cascaded microring resonant cavity is being made, because a photolithography process is limited by resolution of a device, it is difficult to strictly and simultaneously control a space between multiple resonant cavities in processing and production, and even nanometer-level tolerance in a coupling area may also cause a great change in coupling efficiency. Therefore, with increase in a quantity of orders, it is extremely difficult to implement an accurate band-pass function, the microdisk or microring resonant cavity has low coupling efficiency in an inner side of a plane, it is not easy to generate strong coupling, and it is extremely difficult to implement mode splitting on an optical spectrum, which limits application of narrow bandwidth filtering of a cascaded microring resonant cavity and further increase in a switching speed.

### SUMMARY

The present invention provides a resonant cavity component that is used in an optical switching system and that can improve coupling efficiency.

According to a first aspect, a resonant cavity component used in an optical switching system is provided. The resonant cavity component includes: a resonant cavity group, where the resonant cavity group includes at least two resonant cavities that have displacement in a vertical direction, and adjacent resonant cavities exchange optical energy by means of evanescent wave coupling. The resonant cavity component also includes a restriction layer, where the restriction layer is a layer that has a relatively low refractive index and that is located around a resonant cavity and between adjacent resonant cavities. The resonant cavity component also includes at least one optical waveguide, where the at least one optical waveguide is close to a bottom-layer resonant cavity in the resonant cavity group, couples optical energy, and is used to input or output an optical signal.

In a first possible implementation manner of the first aspect, each resonant cavity in the resonant cavity group has displacement in a horizontal direction.

In a second possible implementation manner of the first aspect, a resonant cavity in the resonant cavity group is a closed resonant cavity whose refractive index is greater than the refractive index of a material of the restriction layer.

In a third possible implementation manner of the first aspect, the closed resonant cavity includes a microring resonant cavity, a microdisk resonant cavity, a racetrack resonant cavity, or a polygon resonant cavity.

In a fourth possible implementation manner of the first aspect, the resonant cavity group is prepared by using a CMOS process.

In a fifth possible implementation manner of the first aspect, a thickness of each restriction layer is less than 1 micrometer.

In a sixth possible implementation manner of the first aspect, the at least one optical waveguide includes an input waveguide and an output waveguide, the input waveguide and the output waveguide are close to and coupled to a same bottom-layer resonant cavity, and a space between the input waveguide and the bottom-layer resonant cavity or a space between the output waveguide and the bottom-layer resonant cavity is less than 1 micrometer.

In a seventh possible implementation manner of the first aspect, the at least one optical waveguide includes an input waveguide and an output waveguide, the input waveguide and the output waveguide are coupled to different bottom-layer resonant cavities, and a space between the input waveguide and a bottom-layer resonant cavity or a space between the output waveguide and a bottom-layer resonant cavity is less than 1 micrometer.

In an eighth possible implementation manner of the first aspect, the input waveguide and the output waveguide are placed in a cross manner or placed in parallel.

In a ninth possible implementation manner of the first aspect, the at least one optical waveguide is any one of a straight waveguide, a bent waveguide, a strip waveguide, a ridge waveguide, a conical waveguide, and a slot waveguide.

In a tenth possible implementation manner of the first aspect, the resonant cavity component further includes a controller, configured to provide a control signal that controls refractive index distribution of the resonant cavity group, and the control signal includes an electrical signal, an optical signal, or a magnetic signal.

In an eleventh possible implementation manner of the first aspect, the resonant cavity component further includes an electrode structure located around the resonant cavity group, where the electrode structure receives the control signal of the controller, and adjusts temperature distribution or carrier concentration distribution of the resonant cavity group according to the control signal, or adjusts, according to the control signal, distribution of an electric field imposed on the resonant cavity group.

In a twelfth possible implementation manner of the first aspect, the electrode structure is located near a coupling area between the at least one optical waveguide and the bottom-layer resonant cavity, or a coupling area between resonant cavities.

In a thirteenth possible implementation manner of the first aspect, the resonant cavity component further includes a piezoelectric ceramic structure located around the resonant cavity group, where the piezoelectric ceramic structure receives the control structure, and adjusts a space between resonant cavities in the resonant cavity group according to the control signal.

In a fourteenth possible implementation manner of the first aspect, the resonant cavity component further includes a magnetic pole structure located around the resonant cavity group, where the magnetic pole structure receives the control structure, and adjusts, according to the control signal, distribution of a magnetic field imposed on the resonant cavity group.

In a fifteenth possible implementation manner of the first aspect, the resonant cavity group includes resonant cavities made by using different materials.

In implementation manners of the present invention, multiple resonant cavities have displacement in a vertical direction and are located in different planes, may be prepared by using a CMOS process, for example, a method of thin film deposition; and a space in a vertical direction can be controlled to a level of several nanometers. Compared with plane coupling, a resonant cavity component in the implementation manners of the present invention can implement higher coupling efficiency, it is easier to generate a vernier effect and a physical effect such as mode splitting, and functions of filtering, delay, switching, and the like can be improved.

### BRIEF DESCRIPTION OF THE DRAWINGS

To describe the technical solutions in the embodiments of the present invention more clearly, the following briefly describes the accompanying drawings required for describing the embodiments. Apparently, the accompanying drawings in the following description show merely some embodiments of the present invention, and persons of ordinary skill in the art may still derive other drawings from these accompanying drawings without creative efforts.

FIG. 1 is a schematic diagram of a resonant cavity component used in an optical switching system according to an embodiment;

FIG. 2 is a schematic diagram of a resonant cavity component used in an optical switching system according to an embodiment;

FIG. 3 is a schematic diagram of a resonant cavity component used in an optical switching system according to an embodiment;

FIG. 4 is a schematic diagram of a resonant cavity component used in an optical switching system according to an embodiment;

FIG. 5 is a diagram of a transmittance spectrum of a resonant cavity component shown in FIG. 4; and

FIG. 6 is a schematic diagram of a resonant cavity component used in an optical switching system according to an embodiment.

### DETAILED DESCRIPTION OF ILLUSTRATIVE EMBODIMENTS

The following clearly describes the technical solutions in the embodiments with reference to the accompanying drawings in the embodiments. Apparently, the described embodiments are merely some but not all of the embodiments of the present invention. All other embodiments obtained by persons of ordinary skill in the art based on the embodiments of the present invention without creative efforts shall fall within the protection scope of the present invention.

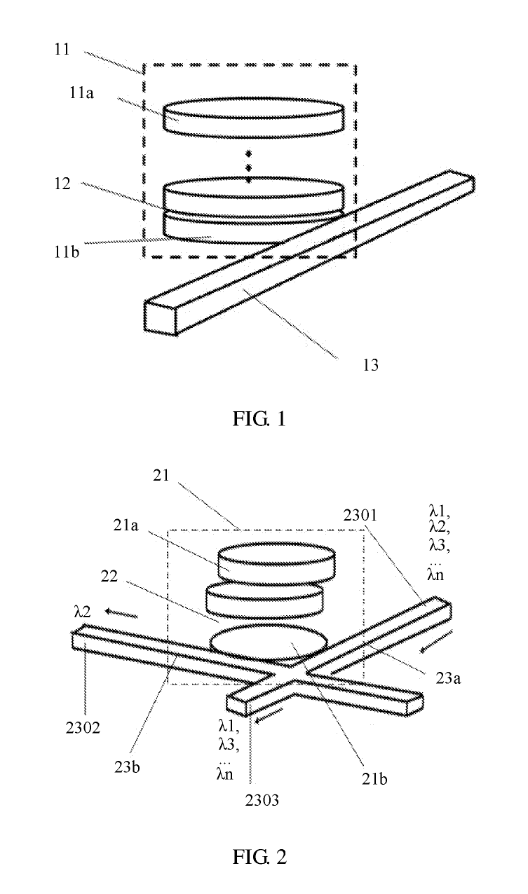

Referring to FIG. 1, a resonant cavity component used in an optical switching system according to an implementation manner 1 includes a resonant cavity group 11, a restriction layer 12, and at least one optical waveguide 13. The resonant cavity group 11 that includes three resonant cavities 11a, the restriction layer 12 between adjacent resonant cavities, and one optical waveguide 13 are merely exemplarily shown in FIG. 1.

The resonant cavities 11a in the resonant cavity group 11 may be the same or may be different, and the resonant cavities 11a have displacement in a vertical direction, where adjacent resonant cavities 11a are separated by the restriction layer 12, and exchange optical energy by means of evanescent wave coupling. A single resonant cavity 11a in the resonant cavity group 11 has displacement in the vertical direction, which indicates that the resonant cavities 11a are located in different planes in the vertical direction, so as to form a hierarchical structure. One or more resonant cavities 11a may be included in a same plane. There is a specific space between adjacent resonant cavities 11a in the vertical direction, and the adjacent resonant cavities 11a are separated by the restriction layer 12 whose thickness is less than 1 micrometer and whose refractive index is relatively low. In this way, the resonant cavity group 11 performs coupling in the vertical direction. Both the resonant cavity group 11 and the optical waveguide 13 are formed on a substrate that is used as a base, and a plane of the substrate is used as a reference plane of the vertical direction.

The resonant cavity group 11 includes at least one bottom-layer resonant cavity 11b, and the bottom-layer resonant cavity 11b may be the same as or may be different from the resonant cavity 11a. The bottom-layer resonant cavity 11b is in the resonant cavity group 11, is located at a bottom layer, and is basically located in a same plane as the optical waveguide 13. There may be one or more bottom-layer resonant cavities 11b.

The optical waveguide 13 is close to the bottom-layer resonant cavity 11b and is coupled to the bottom-layer resonant cavity 11b, and is used to input or output an optical signal.

In one implementation manner, the resonant cavity 11a in the resonant cavity group 11 is a closed resonant cavity. In terms of a specific form, the closed resonant cavity may include a microring resonant cavity, a microdisk resonant cavity, a racetrack resonant cavity, or a polygon resonant cavity.

In one implementation manner, the resonant cavity group 11 is prepared by using a CMOS process. For example, in one implementation manner, the resonant cavity group 11 is prepared by using a thin film deposition process and an overlaying process; that is, in the vertical direction, resonant cavities 11a in the resonant cavity group 11 that are located in a same plane are formed on a thin film, and resonant cavities that are located in different planes form a hierarchical structure by means of overlaying and deposition.

In use, when an optical signal is coupled to the bottom-layer resonant cavity 11b from the optical waveguide 13, signal lights whose resonant wavelengths are the same as that of the bottom-layer resonant cavity 11b are resonant, interact with another resonant cavity 11a in the resonant cavity group 11 by using an outer-cavity evanescent wave, and modulate a characteristic spectrum of the system.

In this implementation manner of the present invention, a resonant cavity group 11 may be prepared by using a CMOS process such as a method of thin film deposition, where a space of resonant cavities 11a in a vertical direction can be controlled to a level of several nanometers. Compared with plane coupling, a resonant cavity component in this implementation manner of the present invention can implement higher coupling efficiency, it is easier to generate a vernier effect and a physical effect such as mode splitting, and functions of filtering, delay, switching, and the like can be improved.

Referring to FIG. 2, a resonant cavity component used in an optical switching system according to an implementation manner 2 includes a resonant cavity group 21, a restriction layer 22, an input waveguide 23a, and an output waveguide 23b. The resonant cavity group 21 that includes three resonant cavities 21a is merely exemplarily shown in FIG. 2, where the resonant cavity group 21 includes a bottom-layer resonant cavity 21b. The input waveguide 23a, the output waveguide 23b, and the bottom-layer resonant cavity 21b are located in a same plane.

The resonant cavities 21a in the resonant cavity group 21 may be the same or may be different, and the resonant cavities 21a have displacement both in a vertical direction and in a horizontal direction, where adjacent resonant cavities 21a are separated by the restriction layer 22, and exchange optical energy by means of evanescent wave coupling. A single resonant cavity 21a in the resonant cavity group 21 has displacement both in the vertical direction and in the horizontal direction, which indicates that the resonant cavities 21a are located in different planes in the vertical direction, so as to form a hierarchical structure. There is a specific space between adjacent resonant cavities 21a in the vertical direction, and the adjacent resonant cavities 21a are separated by the restriction layer 22 whose thickness is less than 1 micrometer and whose refractive index is relatively low. Locations of the resonant cavities 21a are staggered from each other in the horizontal direction, that is, central axes of the resonant cavities 21a do not coincide with each other, and there is a space in the horizontal direction. All of multiple resonant cavities 21a, the input waveguide 23a, and the output waveguide 23b are formed on a substrate that is used as a base, and a plane of the substrate is used as a reference plane of the vertical direction and the horizontal direction.

In this implementation manner, both the input waveguide 23a and the output waveguide 23b are coupled to the bottom-layer resonant cavity 21b, and the bottom-layer resonant cavity 21b may be the same as or may be different from the resonant cavity 21a. The input waveguide 23a and the output waveguide 23b are placed in a cross manner.

In use, the resonant cavity component in the implementation manner 2 is used as a filter. When a column of signal lights whose wavelengths are respectively λ1, λ2, λ3, . . . λn are input from an input port 2301 of the input waveguide 23a, an optical signal that falls into a band-pass window and whose wavelength is λ2 enters the resonant cavity 21b and is downloaded from an output port 2302 of the output waveguide 23b, and remaining signal lights whose wavelengths are respectively λ1, λ3, . . . , Xn are directly output from an output port 2303 of the input waveguide 23a. Displacement of adjacent resonant cavities 21a in the horizontal direction and a space between the adjacent resonant cavities 21a in the vertical direction determine coupling strength, and therefore, a filtering response characteristic of the resonant cavity component is affected, and not only a rectangular filtering window can be implemented, but it can also implemented that an optical spectrum vernier effect is used for expanding a free spectral range.

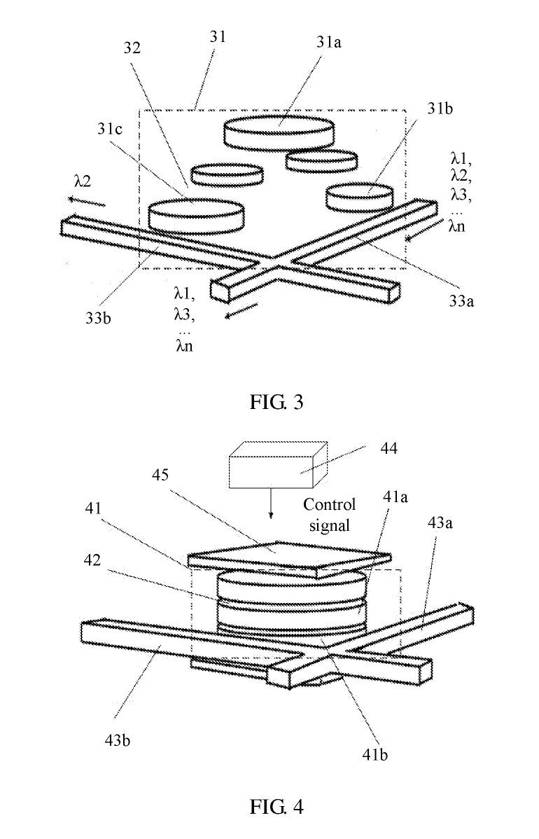

Referring to FIG. 3, an implementation manner 3 is similar to the implementation manner 2, and a resonant cavity component used in an optical switching system includes a resonant cavity group 31, a restriction layer 32, an input waveguide 33a, and an output waveguide 33b. The resonant cavity group 31 that includes five resonant cavities 31a is merely exemplarily shown in FIG. 3, where the resonant cavity group 31 includes two bottom-layer resonant cavities 31b and 31c. The resonant cavities 31a in the resonant cavity group 31 may be the same or may be different, and the bottom-layer resonant cavities 31b and 31c may be the same as or may be different from the resonant cavity 31a. The restriction layer 32 whose thickness is less than 1 micrometer and that has a relatively low refractive index when compared with the resonant cavity group 31 is used to separate resonant cavities 31a. The input waveguide 33a, the output waveguide 33b, and the bottom-layer resonant cavities 31b and 31c are located in a same plane, where the input waveguide 33a is close to and coupled to the bottom-layer resonant cavity 31b, and the output waveguide 33b is close to and coupled to the bottom-layer resonant cavity sic.

In the implementation manner 2 and the implementation manner 3, the input waveguide 23a and the corresponding output waveguide 23b are placed in a cross manner, and the input waveguide 33a and the corresponding output waveguide 33b are placed in a cross manner. In another implementation manner, an input waveguide and an output waveguide may also be placed in parallel.

Referring to FIG. 4, an implementation manner 4 of the present invention is similar to the implementation manners 1 to 3, and a resonant cavity component used in an optical switching system includes a resonant cavity group 41, a restriction layer 42, an input waveguide 43a, and an output waveguide 43b, where the resonant cavity group 41 includes several resonant cavities 41a and includes one bottom-layer resonant cavity 41b. The restriction layer 42 whose thickness is less than 1 micrometer and that has a relatively low refractive index when compared with the resonant cavity group 41 is used to separate the resonant cavities 41a. The resonant cavities 41a in the resonant cavity group 41 may be the same or may be different, and the bottom-layer resonant cavity 41b may be the same as or may be different from the resonant cavity 41a. The input waveguide 43a, the output waveguide 43b, and the bottom-layer resonant cavity 41b are located in a same plane, where both the input waveguide 43a and the output waveguide 43b are close to and coupled to the bottom-layer resonant cavity 41b. The resonant cavity component that is used in an optical switching system and that is in the implementation manner 4 of the present invention further includes a controller 44, and the controller 44 is configured to provide a control signal that controls refractive index distribution of the resonant cavity group 41, where the control signal includes an electrical signal, an optical signal, or a magnetic signal. The controller 44 imposes the control signal on an electrode, a heater, or a magnetic pole 45 near the resonant cavity group 41. Therefore, a resonance frequency of the system changes, and a switching function is implemented for an optical signal on a designated channel. The resonant cavity group 41 may be made by using a material whose refractive index is changeable, and at least some of materials have an electro-optic effect, a thermo-optic effect, a plasma dispersion effect, a birefrigent effect, or a magneto-optic effect.

The resonant cavity component in the implementation manner 4 may be used as a switch component. Because a space between adjacent resonant cavities 41a in a vertical direction can be controlled to several nanometers, it is extremely easy to implement strong coupling, so as to cause mode splitting and obtain a higher quality factor.

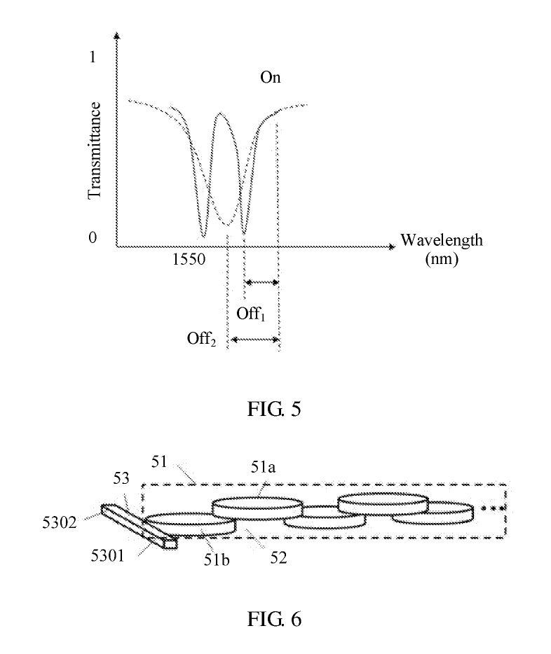

In a transmittance spectrum shown in FIG. 5, a dashed line is a transmittance spectrum of a single resonant cavity, and a solid line is a transmittance spectrum of a resonant cavity group. Because a line width of a resonant peak of a high quality factor of a coupled cavity is narrower, when driven by an external electric field, a center of the resonant peak moves from a switch closed state off1 to a switch connected state on faster than moving from a switch closed state off2 to the switch connected state on, that is, smaller variation of a required refractive index results in a higher speed of switching a switch. Therefore, with a same extinction ratio, a coupled resonant cavity component with a high quality factor can implement a shorter switching time.

In another implementation manner of the implementation manner 4, a piezoelectric ceramic structure is disposed around the resonant cavity group 41. The piezoelectric ceramic structure receives the control signal of the controller 44, and adjusts refractive index distribution of the resonant cavity group 41 according to the control signal or changes a space between adjacent resonant cavities 41a according to the control signal, so that a frequency of the coupling system changes.

Referring to FIG. 6, an implementation manner 5 is similar to the implementation manner 1, and a resonant cavity component used in an optical switching system includes a resonant cavity group 51, a restriction layer 52, an optical waveguide 53. The resonant cavity group 51 is a double-layer structure, and includes several resonant cavities 51a, where several bottom-layer resonant cavities 51b and the waveguide 53 are located in a same plane. The resonant cavity group 51 is connected in series in a horizontal direction, and staggered from each other up and down in a vertical direction, so as to form a cascaded buffer. The restriction layer 52 whose thickness is less than 1 micrometer and that has a relatively low refractive index when compared with the resonant cavity group 51 is used to separate the resonant cavities 51a. The resonant cavities 51a in the resonant cavity group 51 may be the same or may be different, and one optical waveguide 53 and the resonant cavity group 51 that includes five resonant cavities 51a are merely exemplarily shown in the figure.

Because the resonant cavity component in the implementation manner 5 of the present invention may be prepared by using a thin film deposition process, a space between adjacent resonant cavities 51a in a vertical direction and displacement of adjacent resonant cavities 51a in a horizontal direction are controlled more accurately, so as to implement required coupling strength.

When the resonant cavity component is used as the cascaded buffer, and when a optical pulse signal that meets a resonance frequency of the system is input from an input port 5301, the pulse signal enters the cascaded resonant cavity group 51, passes through all the resonant cavity groups 51 at a relatively slow group velocity, and is finally output from an output port 5302, and a signal delay is obtained.

In long-distance communication, it not only requires that the buffer has performance of a long delay, wide bandwidth, low loss, and the like, but also requires a flexible and adjustable delay amount.

In this implementation manner, an electrode may be made around the resonant cavity group 51, so as to change refractive index distribution of the resonant cavity group 51 and implement a tuning function by using an electro-optic effect, a thermo-optic effect, a plasma dispersion effect, a birefrigent effect, a magneto-optic effect, or the like of a material of a resonant cavity. When a center wavelength of an input optical pulse is equal to a resonant wavelength, a group delay of the buffer is the largest; when a center wavelength of an input optical pulse deviates from a resonant wavelength, a group delay of the buffer reduces; and when a center wavelength of an input optical pulse completely deviates from a resonant wavelength, no light is coupled to a resonant cavity, and a group delay of the buffer is zero.

In another implementation manner, an electrode may also be made near a coupling area between the optical waveguide 53 and the resonant cavity group 51, and conversion between three coupling states: overcoupling, critical coupling, and undercoupling is implemented by changing a refractive index of the coupling area, so as to implement flexible adjustment and control of the delay amount.

Certainly, in addition to the foregoing manner of using an electrode structure, a manner that is of using a piezoelectric ceramic structure and a magnetic pole structure and that is provided in the implementation manner 4 may also be used to change the refractive index distribution of the resonant cavity group 51.

In the implementation manners, an optical waveguide may be a single-mode waveguide. In terms of a form, the optical waveguide may be any one of a straight waveguide, a bent waveguide, a strip waveguide, a ridge waveguide, a conical waveguide, and a slot waveguide. The optical waveguide is made by using a material with a high refractive index, which includes but is not limited to a semiconducting material. Multiple resonant cavities that have displacement in a vertical direction and are therefore located in different planes are included in the implementation manners of the present invention, and the resonant cavities may be prepared by using a CMOS process, for example, prepared by using a thin film deposition process. Therefore, the resonant cavities may use different materials, which increases selectivity of materials.

In the implementation manners, a resonant cavity group includes resonant cavities made by using different materials.

In the implementation manners, an input waveguide and an output waveguide may be disposed in a cross manner, or may be disposed in parallel.

Finally, it should be noted that the foregoing embodiments are merely intended for describing the technical solutions of the present invention but not for limiting the present invention. Although the present invention is described in detail with reference to the foregoing embodiments, persons of ordinary skill in the art should understand that they may still make modifications to the technical solutions described in the foregoing embodiments or make equivalent replacements to some technical features thereof, without departing from the spirit and scope of the technical solutions of the embodiments of the present invention.

What is claimed is:

1. A resonant cavity component, comprising:
a resonant cavity group, wherein the resonant cavity group comprises a plurality of resonant cavities that have displacement in a vertical direction, and adjacent resonant cavities exchange optical energy by means of evanescent wave coupling;
a restriction layer, wherein the restriction layer is a layer that has a relatively low refractive index and that is located around a resonant cavity and between adjacent resonant cavities; and
an optical waveguide that is close to a bottom-layer resonant cavity in the resonant cavity group, the optical waveguide configured to couple optical energy and to input or output an optical signal.

2. The resonant cavity component according to claim 1, wherein each resonant cavity in the resonant cavity group has displacement in a horizontal direction.

3. The resonant cavity component according to claim 1, wherein a resonant cavity in the resonant cavity group is a closed resonant cavity whose refractive index is greater than the refractive index of a material of the restriction layer.

4. The resonant cavity component according to claim 3, wherein the closed resonant cavity comprises a resonant cavity of a microring resonant cavity, a microdisk resonant cavity, a racetrack resonant cavity, and a polygon resonant cavity.

5. The resonant cavity component according to claim 1, wherein the resonant cavity group is prepared by using a CMOS process.

6. The resonant cavity component according to claim 1, wherein a thickness of the restriction layer is less than 1 micrometer.

7. The resonant cavity component according to claim 1, wherein the optical waveguide comprises an input waveguide and an output waveguide, the input waveguide and the output waveguide are close to and coupled to a same bottom-layer resonant cavity, and a space between the input waveguide and the bottom-layer resonant cavity is less than 1 micrometer.

8. The resonant cavity component according to claim 7, wherein the input waveguide and the output waveguide are placed in a cross manner or placed in parallel.

9. The resonant cavity component according to claim 1, wherein the optical waveguide comprises an input waveguide and an output waveguide, the input waveguide and the output waveguide are close to and coupled to a same bottom-layer resonant cavity, and a space between the output waveguide and the bottom-layer resonant cavity is less than 1 micrometer.

10. The resonant cavity component according to claim 9, wherein the input waveguide and the output waveguide are placed in a cross manner or placed in parallel.

11. The resonant cavity component according to claim 1, wherein the optical waveguide comprises an input waveguide and an output waveguide, the input waveguide and the output waveguide are coupled to different bottom-layer resonant cavities, and a space between the input waveguide and a bottom-layer resonant cavity is less than 1 micrometer.

12. The resonant cavity component according to claim 1, wherein the optical waveguide comprises an input waveguide and an output waveguide, the input waveguide and the output waveguide are coupled to different bottom-layer resonant cavities, and a space between the output waveguide and a bottom-layer resonant cavity is less than 1 micrometer.

13. The resonant cavity component according to claim 1, wherein the optical waveguide is any one of a straight waveguide, a bent waveguide, a strip waveguide, a ridge waveguide, a conical waveguide, and a slot waveguide.

14. The resonant cavity component according to claim 1, wherein the resonant cavity component further comprises a controller, configured to provide a control signal that controls refractive index distribution of the resonant cavity group, and the control signal comprises an electrical signal, an optical signal, or a magnetic signal.

15. The resonant cavity component according to claim 14, wherein the resonant cavity component further comprises an electrode structure located around the resonant cavity group, the electrode structure receives the control signal of the controller, and adjusts temperature distribution or carrier concentration distribution of the resonant cavity group according to the control signal.

16. The resonant cavity component according to claim 14, wherein the resonant cavity component further comprises an electrode structure located around the resonant cavity group, the electrode structure receives the control signal of the controller, and adjusts, according to the control signal, distribution of an electric field imposed on the resonant cavity group.

17. The resonant cavity component according to claim 16, wherein the electrode structure is located near a coupling area between the optical waveguide and the bottom-layer resonant cavity, or a coupling area between resonant cavities.

18. The resonant cavity component according to claim 14, wherein the resonant cavity component further comprises a piezoelectric ceramic structure located around the resonant cavity group, the piezoelectric ceramic structure receives the control signal, and adjusts a space between resonant cavities in the resonant cavity group according to the control signal.

19. The resonant cavity component according to claim 14, wherein the resonant cavity component further comprises a magnetic pole structure located around the resonant cavity group, the magnetic pole structure receives the control signal, and adjusts, according to the control signal, distribution of a magnetic field imposed on the resonant cavity group.

20. A method of forming resonant cavity component, comprising:
forming a resonant cavity group, wherein the resonant cavity group comprises a plurality of resonant cavities that have displacement in a vertical direction, and adjacent resonant cavities exchange optical energy by means of evanescent wave coupling;
forming a restriction layer, wherein the restriction layer is a layer that has a relatively low refractive index and that is located around a resonant cavity and between adjacent resonant cavities; and
forming an optical waveguide, wherein the optical waveguide is close to a bottom-layer resonant cavity in the resonant cavity group, is configured to couples optical energy, and is configured to input or output an optical signal.
